(19) United States
(12) Patent Application Publication
(10) Pub. No.: US 2009/0254574 A1
(43) Pub. Date: Oct. 8, 2009

(54) METHOD AND APPARATUS FOR PRODUCING AN ONTOLOGY REPRESENTING DEVICES AND SERVICES CURRENTLY AVAILABLE TO A DEVICE WITHIN A PERVASIVE COMPUTING ENVIRONMENT

(75) Inventors: Suparna De, Guildford (GB); Klaus Moessner, Guilford (GB)

Correspondence Address: PARK, VAUGHAN & FLEMING LLP, 2820 FIFTH STREET, DAVIS, CA, 95618-7759, US

(73) Assignee: UNIVERSITY OF SURREY, Guildford (GB)

(21) Appl. No.: 12/062,794

(22) Filed: Apr. 4, 2008

(51) Int. Cl. G06F 17/30

(52) U.S. Cl. 707/100; 707/E17.044

(57) ABSTRACT

One embodiment of the invention provides a method and apparatus for use by a device in a pervasive computing environment. The method includes receiving at the device multiple XML sources describing devices and/or services currently available to said device within the pervasive computing environment. The device then transforms the received multiple XML sources into a single ontology. In one embodiment, the multiple XML sources are first transformed into two or more ontologies, which are then merged into a final single ontology for use by the device.

### FIELD OF THE INVENTION

The present invention relates to producing ontologies, and especially to producing an ontology in relation to a mobile communications environment.

### BACKGROUND OF THE INVENTION

As ubiquitous (pervasive) computing develops, the various networked entities within a particular environment need to be context-aware. Such an environment may be dynamic and heterogeneous in nature. One important aspect of context information to be acquired and processed by a networked entity is a description of available devices and services.

For example, if someone has a presentation on a mobile computing device (MCD), and visits a new site to give the presentation, the MCD may want to interact automatically with other devices at the site: e.g. to find out if there is a projection system available, and/or a sound system available. The MCD might also want to interact with the lighting system in the presentation room to darken the lights during the presentation, as well as the coffee machine, to ensure that hot coffee is available at the end of the talk.

With numerous information sources existing in any given context space, a common, formalised structure is needed for the device and service descriptions. Context information pertinent to devices that are typically involved in pervasive computing is often specified using XML (eXtensible Markup Language). However, it is difficult to perform semantic processing of XML from various sources in a dynamic and heterogeneous environment, especially without a definition of the networked environment at the semantic level.

In computer technology, ontologies have been developed to allow the detailed expression of semantic information. Thus an ontology is used to define the permitted items and behaviours of a logical system. The ontology specifies classes, representing the entities in the system, and properties, which include the possible relationships between different classes.

As an example, if an ontology is built for the class of people, potential properties include “is a sister of” and “is a brother of”. The ontology may specify that if A is a sister of B, and B is a brother of C, then A is also a sister of C. Likewise, the ontology may also specify that the same two objects cannot simultaneously satisfy both properties—i.e. D cannot be both a sister of E and also a brother of E. This property might be specified directly, or might be logically deduced from other properties. For example, it might be specified that a person can only be male or female (i.e. these are mutually exclusive), and that only females can be a sister of somebody, and only males can be a brother of somebody.

In computing, ontologies are primarily being developed in the context of Web 2.0 technology, in particular using the Web Ontology Language (OWL), which is the emerging standard language for defining and instantiating ontologies. In addition, OWL has good tool support.

It is hoped that data published on the web will be classified or expressed in conformity with an ontology. This will then greatly enhance the ability of search engines and other programs to automatically retrieve information over the web. Thus existing search engines are generally based on a statistical analysis of word frequencies and locations, without understanding the intrinsic meaning of the words, and this makes certain types of searching difficult. An example would be trying to find books having a story set in Turkey. Entering “story country turkey book” into Google produced as the top hit an article about a book concerning expats living in Turkey, and as a second top hit an article about a book including a recipe for cooking turkey. Using an ontology would allow data relationships to be formalised, e.g. including ideas such as the setting of a book, and so help to address such problems.

However, so far there has been relatively little development regarding the use of ontologies for representing device and service capabilities in a mobile communications network.

### SUMMARY OF THE INVENTION

One embodiment of the invention provides a method for use by a device in a pervasive computing environment. The method comprises receiving at the device multiple XML sources describing devices and/or services currently available to the device within the pervasive computing environment; and transforming by the device the multiple XML sources into a single ontology instance representing the devices and/or services currently available to the device within the pervasive computing environment.

In this approach, XML service and device descriptions in a mobile communications environment (also referred to as a pervasive or ubiquitous computing environment) can be converted and combined into an ontology to provide seamless retrieval of the context information, as well as its exploitation via automated reasoning.

Other embodiments of the invention also provide a device and a computer program for implementing such a method.

Another embodiment of the invention provides a computer-implemented method for automatically combining multiple ontology instances sharing the same domain ontology. The method comprises typecasting each of the multiple ontology instances into a corresponding set of RDF (Resource Description Framework) statements; performing a union operation on the sets of RDF statements corresponding to the multiple ontology instances; and typecasting the resulting single set of RDF statements back to an ontology to produce the combined ontology instance.

In contrast to existing approaches, the techniques described herein can be fully automated (i.e. without run-time human input), and also avoid having to place additional limitations on the ontology instances to be merged, such that they must adopt a predefined shared vocabulary, providing they refer to the same domain ontology (although the merging is independent of the specific referenced domain ontology). Furthermore, individuals and properties in the ontology instances are merged (not just classes), and duplicate entities under the same asserted individual are dropped (without loss of information).

### BRIEF DESCRIPTION OF THE DRAWINGS

Various embodiments of the invention will now be described in detail by way of example only with reference to the following drawings:

FIG. 1 is a high-level flowchart depicting a method in accordance with one embodiment of the invention.

FIG. 2 is a flowchart depicting in more detail the pre-processing stage from the method of FIG. 1 in accordance with one embodiment of the invention.

FIG. 3 is a flowchart depicting in more detail the core processing stage from the method of FIG. 1 in accordance with one embodiment of the invention.

FIG. 4 is a flowchart depicting in more detail the first stage of the core processing shown in FIG. 3 in accordance with one embodiment of the invention.

FIG. 5 is a flowchart depicting in more detail the second stage of the core processing shown in FIG. 3 in accordance with one embodiment of the invention.

FIG. 6 is a flowchart depicting in more detail the post-processing stage from the method of FIG. 1 in accordance with one embodiment of the invention.

FIG. 7 is a flowchart depicting in more detail the loading step from the post-processing stage shown in FIG. 6 in accordance with one embodiment of the invention.

FIG. 8 is a schematic flowchart depicting an overall processing flow in accordance with one embodiment of the invention, as per the flowcharts of FIGS. 1-7.

FIG. 9 is a high-level flowchart depicting a method in accordance with another embodiment of the invention.

FIG. 10 is a flowchart depicting in more detail the pre-processing stage from the method of FIG. 9 in accordance with one embodiment of the invention.

FIG. 11 is a flowchart depicting in more detail the core processing stage from the method of FIG. 9 in accordance with one embodiment of the invention.

FIG. 12 is a flowchart depicting in more detail the merging step of the core processing shown in FIG. 11 in accordance with one embodiment of the invention.

FIG. 13 is a schematic flowchart depicting an overall processing flow in accordance with another embodiment of the invention, as per the flowcharts of FIGS. 10-12.

FIG. 14 is a schematic flowchart depicting an overall processing flow in general accordance with the embodiment of FIG. 8, for one particular example of input data.

FIG. 15 is a screen shot illustrating a domain ontology used as input data in the example of FIG. 14.

FIG. 16 is a screen shot illustrating a first ontology instance produced as an intermediate product in the example of FIG. 14.

FIG. 17 is a screen shot illustrating a second ontology instance produced as an intermediate product in the example of FIG. 14.

FIG. 18 is a screen shot illustrating a merged ontology instance produced as an output for the example of FIG. 14.

FIG. 19 is a schematic diagram showing an example of a system for implementing the method of FIG. 1 in accordance with one embodiment of the invention.

### DETAILED DESCRIPTION

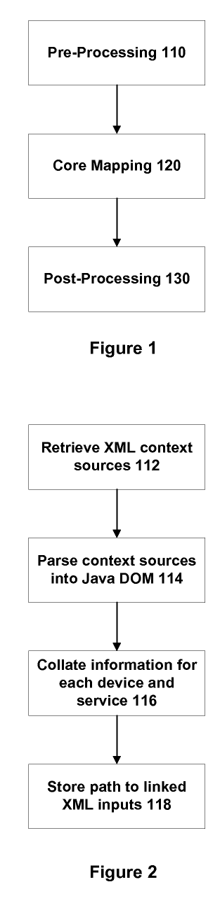

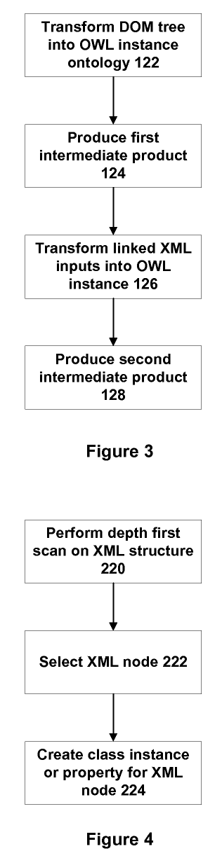

FIG. 1 is a high-level flowchart depicting a method in accordance with one embodiment of the invention. The method converts (multiple) input XML description sources into a single, composite output ontology. The method comprises three parts, a pre-processing step 110, a core mapping 120, and a post-processing step 130. The pre-processing step 110 converts XML context sources into a tree structure. The core processing step 120 converts the tree structure into a first ontology instance and linked XML sources into a second ontology instance. The post-processing step 130 merges the first and second ontology instances into a single ontology instance. The operations of FIG. 1 will now be described in more detail, with reference to FIGS. 2-6.

FIG. 2 is a flowchart depicting in more detail the pre-processing step 110 from the method of FIG. 1 in accordance with one embodiment of the invention. In the pre-processing step 110, the XML context sources to be processed are retrieved 112. In a mobile environment, such context sources may be retrieved using a discovery framework. Next, the XML context sources are parsed into a Java Document Object Model (DOM) 114. The DOM comprises a tree of nodes created from the XML structure, with each node being either an element node or a text node containing the value of the element. The DOM represents the entire XML document and provides primary access to the data in the document. The processing collates information from each source (e.g. for each device and service) into a single DOM tree 116. The collation operation 116 may be integrated into the parsing operation 114 by recursively processing each discovered device. The resulting DOM may be used directly as input to the core mapping stage 120 without further modification. In addition, the parsing operation 114 includes determining the path of the profile repository which stores the linked XML input sources. In other words, this represents the location of XML input sources that are referenced by (linked to) the XML context sources originally retrieved at operation 112. This path (or paths) is/are stored for later processing 118.

FIG. 3 is a flowchart depicting in more detail the core processing step 120 from the method of FIG. 1 in accordance with one embodiment of the invention. The method involves a first stage of applying mapping rules to the DOM structure from the pre-processing stage 110 to transform the tree representation of the context information into an OWL instance ontology. The OWL instance ontology, which references the existing domain ontology, forms the first intermediate product 124. In a second stage, the linked XML inputs from the repository are processed into an OWL instance ontology 126, which again references the existing domain ontology, and this second OWL instance ontology is output as the second intermediate product 128.

(The domain ontology is defined in generic, abstract terms, for example in respect of devices and services that are potentially available in a pervasive computing network. The instance ontology then defines a particular implementation of the domain ontology. The instance ontology specifies the subset of those particular devices and services from the domain that are currently available—including the number of such devices and services that are currently available).

FIG. 4 is a flowchart depicting in more detail the first stage 122 of the core processing shown in FIG. 3 in accordance with one embodiment of the invention. In applying mapping rules to the DOM structure to transform the tree representation of the context information into an OWL instance ontology, all discovered devices are mapped by applying a depth first scan to the XML structure 220 from the pre-processing stage 110. The root node is a device node, which is mapped to an independent individual, and its child nodes are then processed linearly. The depth scan is repeated recursively, back-tracking each time a leaf node is reached in the tree structure, until the whole tree has been processed.

The mapping itself is performed using XSLT (Extensible Stylesheet Language Transformation) technology. The XSLT script utilises XPATH expressions to select XML nodes from the tree 222. (XPATH is an XML path language, and is a language for addressing parts of an XML document; further details are available at http://www.w3.org/TR/xpath). For each matched XML node selected with an XPATH expression, either an instance of the mapped OWL class is created, or an object or data-type property is added between corresponding individuals 224. The properties are generated in-place within the depth scan.

(N.B. Other known mechanisms for direct mapping from XML into ontologies include the WEESA framework—see http://www.infosys.tuwien.ac.at/weesa/, which defines a mapping from XML to RDF (Resource Description Framework) by defining rules between an existing OWL ontology and the corresponding XML schema. The mapping is done manually and generates RDF from the XML instance document, but not the equivalent OWL instances. Another approach is the XML2OWL framework—see http://sourceforge.net/projects/xml2owl, which addresses the translation process from XML instance data to OWL instances. This framework is implemented in XSLT (Extensible Stylesheet Language Transformation). This approach does not provide any additional semantic enrichment beyond that of the XML document or schema. A further approach is the XMLTOWL framework, in which rules are created manually to map XML instances to OWL individuals. The mapping uses XPATH. The XMLTOWL framework is described in “Mapping XML to OWL for seamless information retrieval in context-aware environments”, by Kobeissy, Nassim; Genet, Marc; and Zeghlache, Djamal, in the IEEE International Conference on Pervasive Services, 15-20 Jul. 2007 Page(s):361-366).

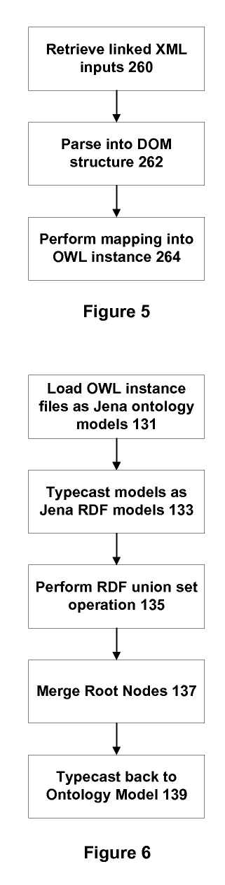

FIG. 5 is a flowchart depicting in more detail the second stage 126 of the core processing shown in FIG. 3 in accordance with one embodiment of the invention. Note that the overall processing in FIG. 5 is somewhat similar to that performed with respect to the initial XML sources in the pre-processing step and in the first stage of the core processing step.

Thus the second stage of the core processing operation retrieves the linked XML inputs from the central repository 260 (c.f. step 118 of the pre-processing shown in FIG. 2). The linked XML inputs are then parsed into a DOM structure 262, analogous to step 114 of the pre-processing shown in FIG. 2. The DOM structure is then mapped into the relevant OWL instance 264, analogous to step 122, the first stage of the core processing shown in FIG. 3 (and as illustrated in more detail in FIG. 4).

FIG. 6 is a flowchart depicting in more detail the post-processing step 120 from the method of FIG. 1 in accordance with one embodiment of the invention. The post-processing step merges a first ontology instance (the first intermediate product produced at step 124 in FIG. 3) with a second ontology instance (the second intermediate product produced at step 128 in FIG. 3). The output is a single ontology instance that provides a complete, comprehensive, cohesive semantic representation of the various context sources in the ambient environment.

In effect, the following logical operation is being performed:

OntInstance_{A}U OntInstance_{B}→CompleteOntModel

where OntInstance_{A} corresponds to the first intermediate product and OntInstance_{B} corresponds to the second intermediate product.

There are no standard algorithms for merging ontologies. Of the facilities that are available, one is the Prompt plug-in to the Protege OWL editor (available from http://protege.stanford.edu/plugins/prompt/prompt.html). This tool can be used for the merging and alignment of ontologies (that do not necessarily have to share the same domain ontology). A semi-automated algorithm is employed that helps a user to merge ontologies by providing suggestions regarding classes and properties to be merged, based on similarity of name. With every user action, associated concepts are then merged automatically, and conflict resolution steps are suggested for any conflicts that arise. Because of the user input involved in the ontology merging, this tool is not generally suitable for use in the pervasive computing context of one embodiment of the present invention.

Other reported approaches for merging ontologies include OntoMerge and Chimaera (described at: http://cs-www.cs.yale.edu/homes/dvm/daml/ontology-translation.html and http://www-ksl.stanford.edu/software/chimaera/respectively). These two tools are also semi-automated and rely on the user to resolve inconsistencies and to provide adequate knowledge extraction. For this reason, such systems are again generally unsuitable for use in the pervasive computing context of one embodiment of the present invention. SAMBO is another semi-automated system, this time specifically for aligning and merging biomedical source ontologies (see http://www.ida.liu.se/˜iislab/projects/SAMBO/). The matching of terms is based on linguistic elements, structure (“is a” relationships), constraint-based methods, or a combination of such techniques.

A somewhat different approach is discussed in: “A Language and Algorithm for Automatic Merging of Ontologies”, by R. Alma Delia Cuevas and G. Adolfo Arenas, presented at 15th International Conference on Computing, CIC '06, 2006. This describes an automated method of merging domain ontologies but relies on sources using a specific ontology merging notation. Accordingly, the method cannot be used in respect of ontologies that do not incorporate such notation.

Another approach is described in “A New Methodology for Merging the Heterogeneous Domain Ontologies Based on the WordNet” by Hyunjang, Myunggwon and Pankoo, in Proceedings of the International Conference on Next Generation Web Services Practices, 2005, page 235, ISBN:0-7695-2452-4. This approach proposes a method for merging heterogeneous domain ontologies based on the WordNet ontology, and applies to merging classes in two different domain ontologies on the same subject by computing a similarity measure. However, merging of attributes and properties is not handled in this approach.

The approach developed in accordance with one embodiment of the present invention for merging ontology instances begins by loading the two input ontology files into memory as Jena ontology models 131. Jena is a Java framework for building semantic web applications and is available from http://jena.sourceforge.net/index.html. Jena provides a programming environment for RDF (Resource Description Framework), RDFS (RDF Schema), OWL, and the SPARQL query language for RDF. Jena further includes a rule-based inference engine; an RDF API to extract data from and write data to RDF graphs; and a Java ontology API.

Since there is no specific API in Jena for merging ontology instances, the two loaded Jena ontology models (say M1 and M2) are typecast as (transformed into) Jena RDF models 133. The RDF union set operation is then used 135 to product a union of the set of statements representing each of the original ontology models. This can be logically represented as M=rdf(M1)Urdf(M2). The merging of root nodes is determined by rdf:ID so that any two individuals with the same name (i.e. with the same rdf:ID) are merged 137. Since a UUID (Universally Unique Identifier) tag can be used to enforce a unique ID for each device, this ensures that the correct individual pairs from the two models are merged. In particular, the root nodes are merged into one, and duplicate nodes beneath the root node can then be dropped. The resulting RDF model is then typecast back into an ontology model 139, in other words, creating OntM from M, and written out as an OWL file representing the final combined ontology corresponding to the various XML source inputs.

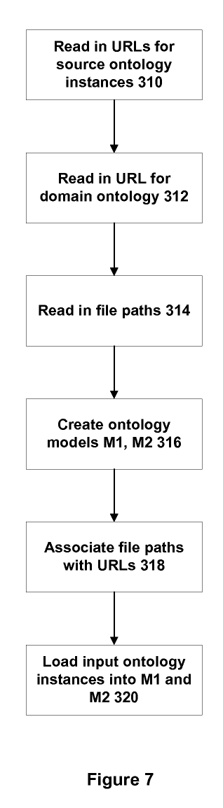

FIG. 7 is a flowchart depicting in more detail the loading step 131 from the post-processing stage shown in FIG. 6 in accordance with one embodiment of the invention. The method commences with reading URLs for the source ontology instances into the Jena framework 310. The URL for the domain ontology corresponding to the ontology instances is also read into the Jena framework 312. The file paths for the source ontology instances and for the domain ontology are read into the Jena framework 314.

The system now creates ontology models (e.g. M1 and M2) within the Jena framework 316. The file paths for the source ontology instances (and for the domain ontology) are associated with the corresponding URLs for the source ontology instances and the domain ontology by making alternate entries in the model's Document manager 318. Lastly, the input ontology instances are loaded into the ontology models M1 and M2, whereupon the system is ready for the further post-processing as discussed above in relation to FIG. 6 (operations 133 and onwards).

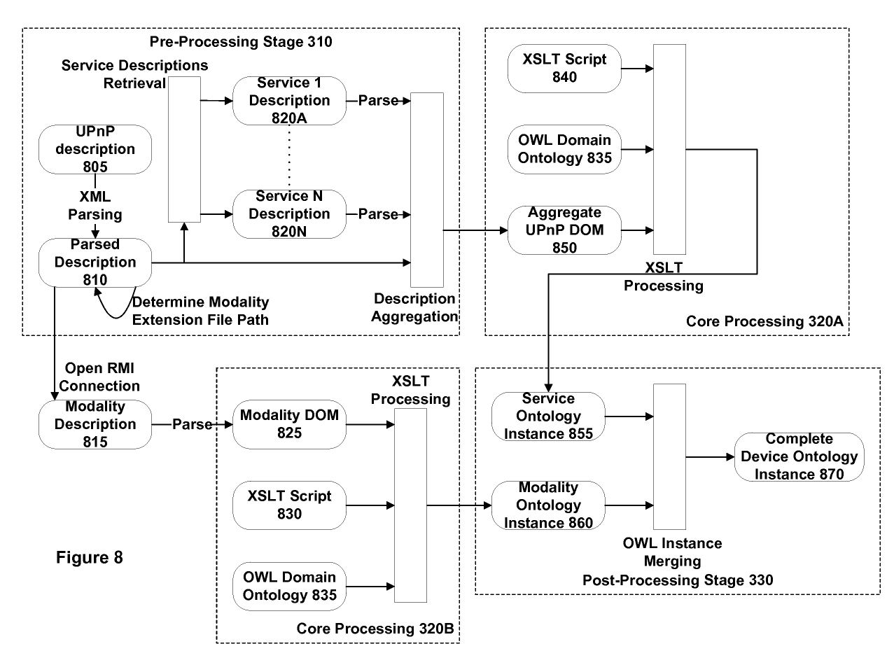

FIG. 8 is a schematic flowchart depicting an overall processing flow in accordance with one embodiment of the invention. As in the method of FIG. 1, the processing is split into three high-level stages: a pre-processing block 310, a core processing block 320, and a post-processing block 330.

The pre-processing stage takes as its input one or more UPnP descriptions 805 (conforming to the Universal Plug and Play discovery protocol, see http://www.upnp.org/). XML parsing is performed on the UPnP description(s) to produce a parsed description 810. Processing now bifurcates. In one branch, one or more service descriptions 820A, 820B . . . 820N are retrieved (c.f. step 112 in FIG. 2). These service descriptions are then parsed (c.f. step 114 in FIG. 2) and aggregated together to form a single DOM 850 (c.f. step 116 in FIG. 2). In the other branch, the parsed description 110 is processed to determine the file path(s) for any modality extensions (c.f. step 118 in FIG. 2). A remote method invocation (RMI) connection is then opened to access the description(s) 815 for such modality extensions (c.f. step 260 in FIG. 5). The descriptions are then parsed and aggregated to form a modality DOM 825 (c.f. step 262 in FIG. 5).

The core processing is split into two blocks. The first core processing block 320A operates on the aggregate DOM 850, which is transformed by XSLT processing to produce a service ontology instance 855 (c.f step 122 in FIG. 3 and the processing of FIG. 4). This transformation utilises an XSLT script 840 and the OWL domain ontology 835. The second core processing block 320B operates on the modality DOM 825, which is transformed by XSLT processing to produce a modality ontology instance 860 (c.f. step 126 in FIG. 3 and step 264 in FIG. 5). This transformation again utilises an XSLT script 8830 and the OWL domain ontology 835.

Finally, the post-processing stage 330 merges the service ontology instance 855 and the modality ontology instance 860 to produce the complete device ontology instance 870 (c.f. the processing of FIG. 6).

In contrast to existing approaches, the approach described in FIGS. 1-8 can be fully automated (i.e. without run-time human input). The approach also avoids having to place additional limitations on the ontology instances to be merged, such that they must adopt a predefined shared vocabulary, providing they refer to the same domain ontology (although the merging is independent of the specific referenced domain ontology). Rather the merging is independent of the referenced domain ontology. Furthermore, individuals and properties in the ontology instances are merged (not just classes), and duplicate entities under the same asserted individual are dropped (without loss of information).

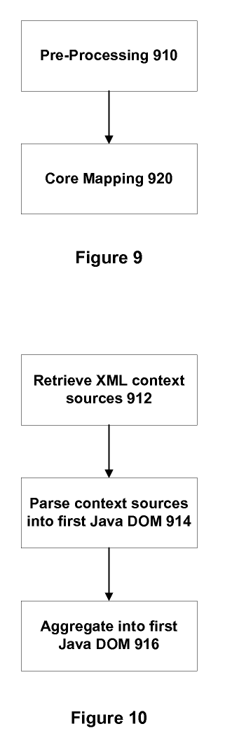

FIG. 9 is a high-level flowchart depicting a method in accordance with another embodiment of the invention. The method again converts (multiple) input XML description sources into a single, composite output ontology. The method of FIG. 9 comprises two parts, a pre-processing step 910 and a core mapping 920. The pre-processing step 110 converts XML context sources into a first tree structure. The core processing step 120 converts linked XML sources into a second tree structure, and merges the first and second tree structures. The merged tree structure is then transformed into an ontology instance. In this second embodiment, there is no post-processing step (unlike the method illustrated in FIG. 1). The operations of FIG. 9 will now be described in more detail, with reference to FIGS. 10-12.

FIG. 10 is a flowchart depicting in more detail the pre-processing step 910 from the method of FIG. 9 in accordance with one embodiment of the invention. The pre-processing step 910 is generally similar to the pre-processing step 110 for the method shown in FIG. 1. Thus the XML context sources to be processed are retrieved 912. In a mobile environment, such context sources may be retrieved using a discovery framework. Next, the XML context sources are parsed into a (first) Java Document Object Model (DOM) 914. The DOM comprises a tree of nodes created from the XML structure, with each node being either an element node or a text node containing the value of the element. The processing then aggregates the information from each source (e.g. for each device and service) into a single DOM tree 916. The aggregation operation 916 may be integrated into the parsing operation 914 by recursively processing each discovered device.

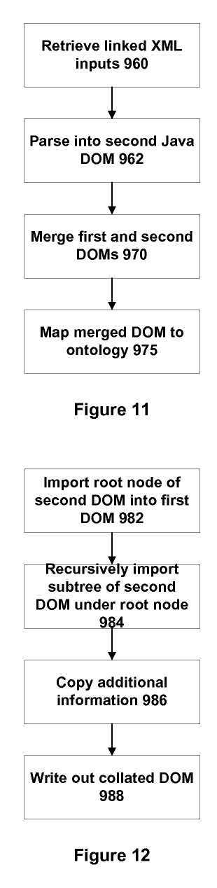

FIG. 11 is a flowchart depicting in more detail the core processing stage from the method of FIG. 9 in accordance with one embodiment of the invention. In the approach of FIG. 11 (and unlike the method shown in FIGS. 1-7), the linked XML inputs for the modality extensions are retrieved in-place as soon as the path of the repository for such inputs is parsed 960. The retrieved (modality) XML document is then parsed into a second DOM structure 962 (in the same way as described above in respect of step 262 in FIG. 5).

Rather than transforming the two DOM structures separately into ontologies, and then merging the ontologies together (as for the method shown in FIGS. 1-7), in the embodiment of FIG. 11 the two DOM structures themselves are merged together 970 into a single DOM tree. This single DOM tree is then transformed into (a single) OWL instance ontology 975, using the same general approach as described above for FIG. 4, using appropriate parts of an XSLT script applied to the modality and service descriptions.

FIG. 12 is a flowchart illustrating in more detail the merging step 970 of FIG. 11 in accordance with one embodiment of the invention. The merger involves importing the root node of the second (modality) DOM into the first (service) DOM 982. A deep copy of the modality DOM is then made by recursively importing the subtree under the imported root node (of the second tree) 984. Additional information related to the element nodes is also copied to mirror the behaviour expected if an XML fragment were copied from one document to another, recognising the fact that the two fragments have different schema 986. The import step also prevents any document ownership conflicts. The collated (aggregate) DOM is then written out as an XML file 988 (this is used to measure the impact of the intermediate product).

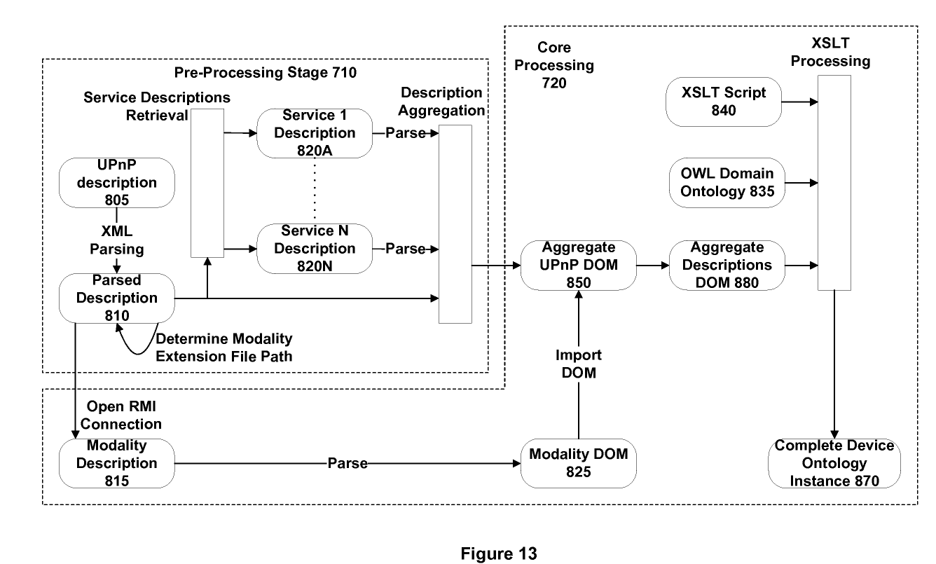

FIG. 13 is a schematic flowchart depicting an overall processing flow in accordance with one embodiment of the invention. As in the method of FIG. 9, the processing is split into two high-level stages: a pre-processing block 710 and a core processing block 720.

The pre-processing stage 710 generally corresponds to the pre-processing stage 310 of FIG. 8. Thus pre-processing stage 710 takes as its input one or more UPnP descriptions 805 (conforming to the Universal Plug and Play initiative, see http://www.upnp.org/). XML parsing is performed on the UPnP description(s) to produce a parsed description 810. Processing now bifurcates. In one branch, one or more service descriptions 820A, 820B . . . 820N are retrieved (c.f. step 912 in FIG. 10). These service descriptions are then parsed (c.f. step 914 in FIG. 10) and aggregated together to form a single DOM 850 (c.f. step 916 in FIG. 10). In the other branch, the parsed description 110 is processed to determine the file path(s) for any modality extensions. A remote method invocation (RMI) connection is then opened to access the description(s) 815 for such modality extensions (c.f. step 960 in FIG. 11). The descriptions are then parsed and aggregated to form a modality DOM 825 (c.f. step 962 in FIG. 5).

In the core processing, the modality description 815 is parsed to produce a modality DOM 825 (c.f. step 962 in FIG. 11). This modality DOM is imported into the aggregate UPnP DOM 850 (c.f. steps 982 and 984 of FIG. 12) to produce a single DOM 880 representing the combined or aggregate descriptions. This single DOM is then transformed via XSLT processing, using an XSLT script 840 and the OWL domain ontology 835, to produce the complete device ontology instance 870 (c.f. step 975 in FIG. 11).

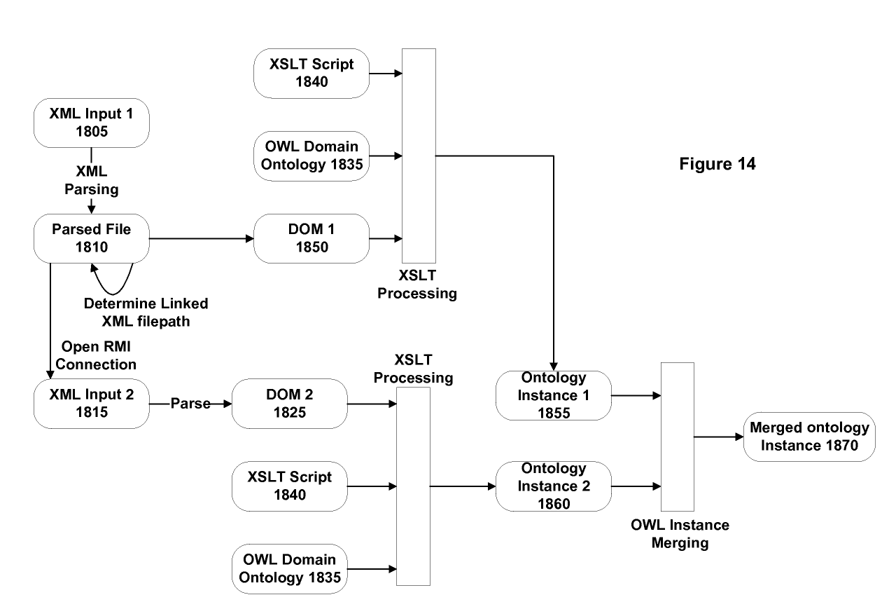

A particular example of the transformation of multiple XML sources into a single ontology instance will now be described. The general configuration for this processing is illustrated in FIG. 14. Note that the processing of FIG. 14 corresponds closely to that of FIG. 8 (apart from some simplification of the pre-processing stage 310 due to the limited number of XML input files in this particular example), and the associated flowcharts of FIGS. 1-7. Accordingly, these earlier Figures and their associated discussion should also be referred to in order to assist in understanding FIG. 14.

The example of FIG. 14 involves an XML input file, XML Input-1 1805, which contains information about an entity, a person, in particular, his name (Jack), age (23) and residence (England). The contents of XML Input-1 1805 are listed in Table 1 below.

TABLE 1
XML Input 1

```
<?xml version=“1.0” encoding=“UTF-8”?>
<Persons>
    <Person>
        <name>Jack</name>
        <age>23</age>
        <residence>England</residence>
    <otherXml>http://localhost/ipxml2.xml</otherXml>
    </Person>
</Persons>
```

Note that XML Input-1 1805 includes a tag that links to a second XML file in the line: <otherXml>http://localhost/ipxml2.xml</otherXmI>

When the XML Input-1 1805 is parsed 1810, the path-name for this link is identified and accessed to retrieve the second XML file, XML Input-2 1815. The contents of XML Input-2 1815, which also relate to Jack, and which specify his name (Jack), his pet (Fido), and his residence (England), are listed in Table 2 below.

TABLE 2
XML Input 2

```
<?xml version=“1.0” encoding=“UTF-8”?>
<Persons>
    <Person>
        <name>Jack</name>
        <pet>Fido</pet>
        <residence>England</residence>
    </Person>
</Persons>
```

Each of the two XML Inputs is (independently) converted into a corresponding document object model, DOM-1 1850 for XML Input-1 1805, and DOM-2 1825 for XML Input-2 1815. Each of the two DOMs is then (independently) transformed into a corresponding ontology, Ontology Instance-1 1855 for DOM-1 1850 and Ontology Instance-2 for DOM-2 1825.

The transformation from a DOM file to an ontology instance utilises an XSLT script 1840 and the OWL Domain Ontology 1835. The OWL Domain Ontology 1835 is a domain file that defines the target ontology domain specification, while the XSLT script 1840 contains rules to transform the XML input into an ontology instance file. The same XSLT script 1840 and OWL Domain Ontology 1835 are used in both transformations—i.e. in the production of Ontology Instance-1 1855 from DOM-1 1850 and in the production of Ontology Instance-2 from DOM-2 1825. The XSLT script 1840 is listed in Table 3 below:

TABLE 3
XSLT Script

```
<?xml version=“1.0” encoding=“UTF-8”?>
<xsl:stylesheet version=“2.0”
xmlns:xsl=“http://www.w3.org/1999/XSL/Transform”
xmlns:fo=http://www.w3.org/1999/XSL/Format...”>
<xsl:output method=“xml” version=“1.0” encoding=“UTF-8”
indent=“yes” />
<xsl:template match=“/”>
<rdf:RDF xmlns=http://www.owl-ontologies.com/InstanceOnt.owl# ......
<owl:Ontology rdf:about=“”>
  <owl:imports rdf:resource=“http://www.owl-ontologies.com/
  Person.owl”/>
  </owl:Ontology>
  <xsl:for-each select=“Persons/Person”>
        <xsl:variable name=“pName”><xsl:value-of
select=“name”/></xsl:variable>
        <xsl:variable name=“pet”><xsl:value-of
        select=“pet”/></xsl:variable>
        <xsl:variable name=“country”><xsl:value-of
select=“residence”/></xsl:variable>
        <xsl:if test=“count(pet) > 0”>
            <p1:Pet rdf:ID=“{$pet}”/>
        </xsl:if>
        <xsl:if test=“count(residence) > 0”>
            <p1:Country rdf:ID=“{$country}”/>
        </xsl:if>
        <p1:Person rdf:ID=“{$pName}”>
            <xsl:if test=“count(age) > 0”>
                <p1:hasAge
rdf:datatype=“http://www.w3.org/2001/XMLSchema#int”><xsl:value-of
select=“age”/></p1:hasAge>
            </xsl:if>
            <xsl:if test=“count(pet) > 0”>
                <p1:hasPet rdf:resource=“#{$pet}”/>
            </xsl:if>
            <xsl:if test=“count(residence) > 0”>
              <p1:livesIn rdf:resource=“#{$country}”/>
            </xsl:if>
        </p1:Person>
  </xsl:for-each>
</rdf:RDF>
</xsl:template>
</xsl:stylesheet>
```

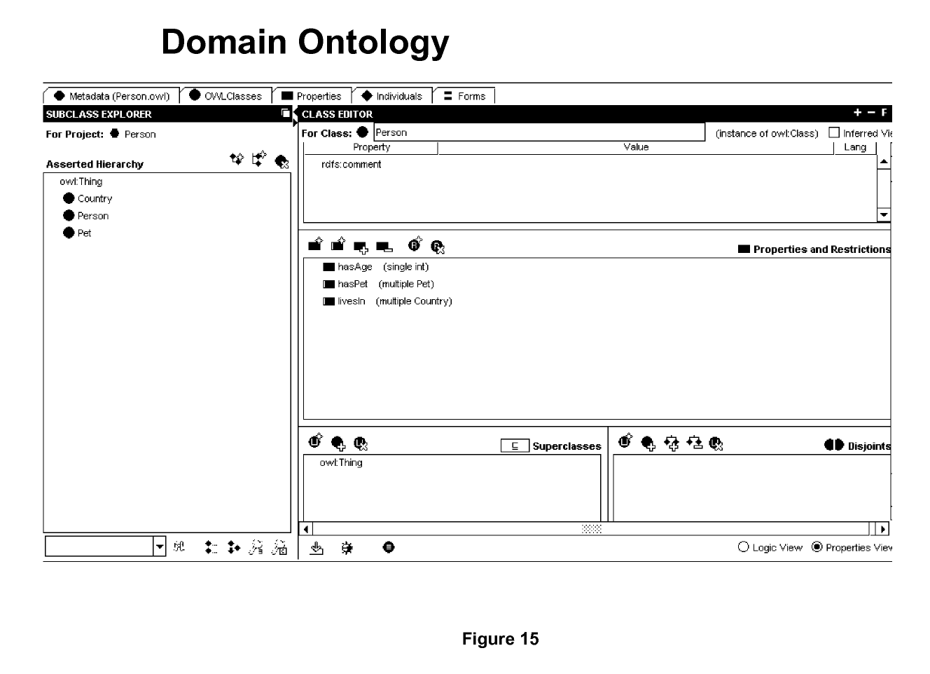

Note that the XSLT script 1840 references (and is dependent on) the particular OWL domain ontology 1835. FIG. 15 presents a screen-shot illustrating the OWL domain ontology 1835, which in particular defines the class “Person” and various properties of this class, namely “hasAge”, “hasPet”, and “livesIn”.

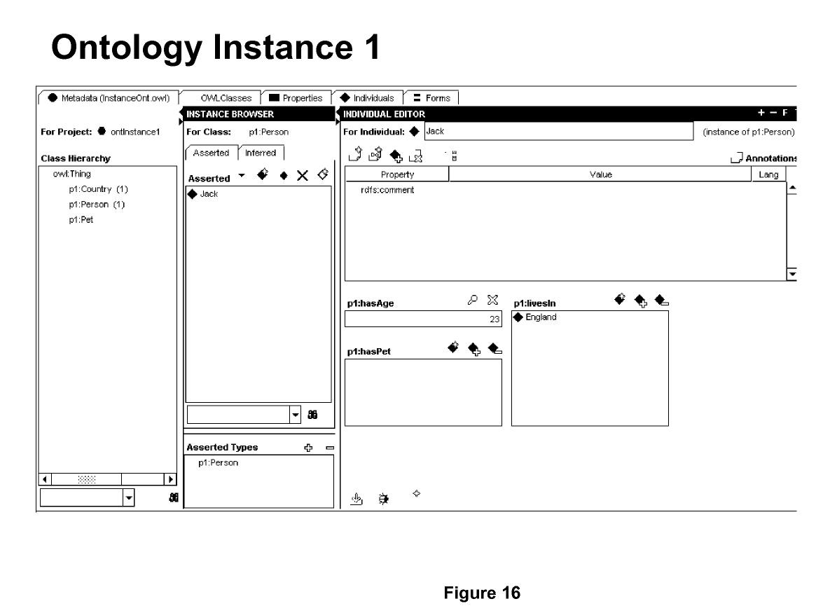

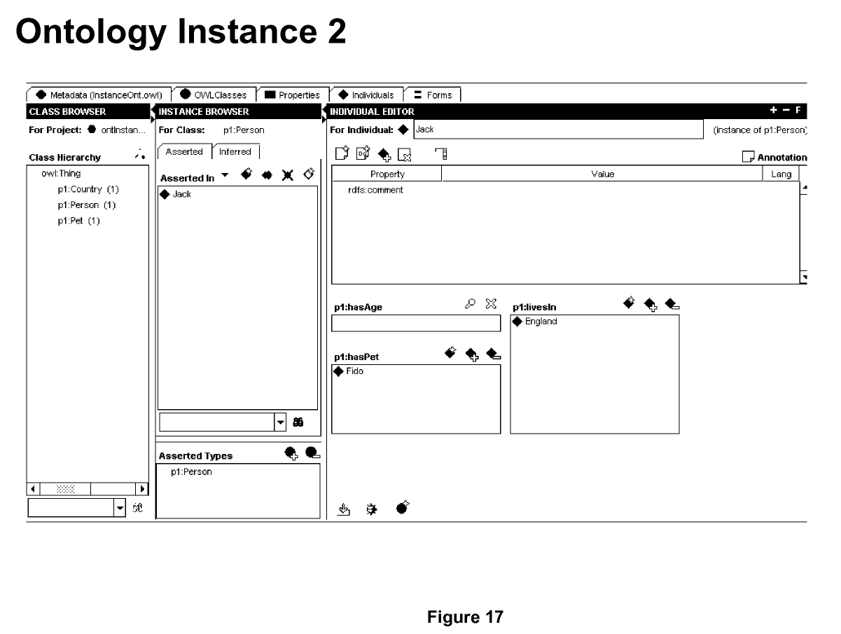

FIGS. 16 and 17 are screen-shots illustrating Ontology Instance-1 1855 and Ontology Instance-2 1825 respectively. It can be seen that the relevant properties now relate to the specific individual Jack, who is an instance of a Person (rather than to the general class of person).

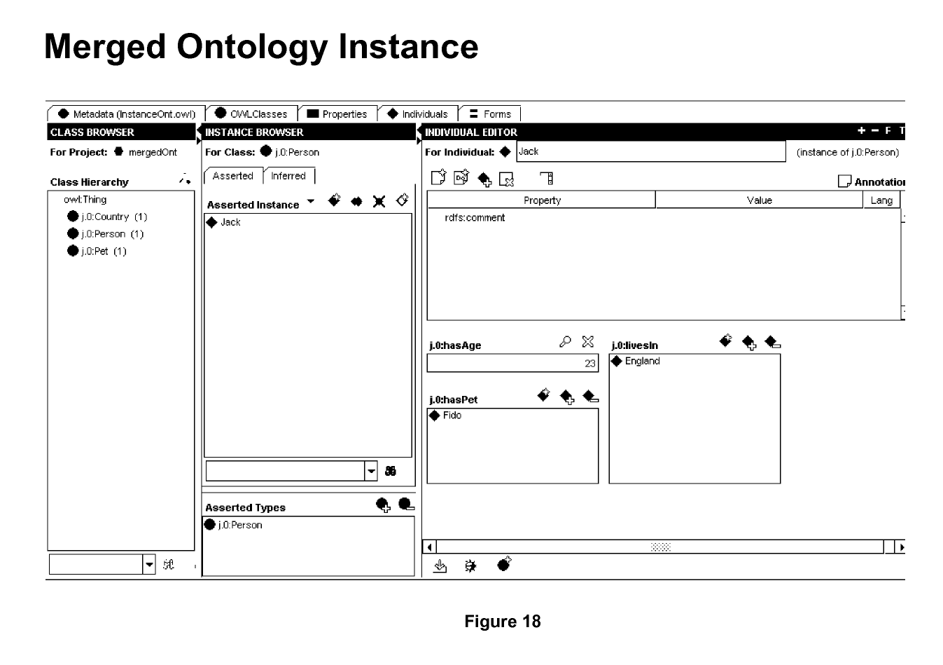

FIG. 18 is a screen-shot illustrating the merged ontology instance 1870 formed from the combination of Ontology Instance-1 1855 and Ontology Instance-2 1825 (the combination or merging being performed as described above). It can be seen that in the merged ontology, the individual Jack now has the full set of properties, representing a superset (union) of the properties from the two original XML input files 1805, 1815. In particular, the merged ontology 1870 specifies that Jack has an age 23, lives in England, and has a pet Fido.

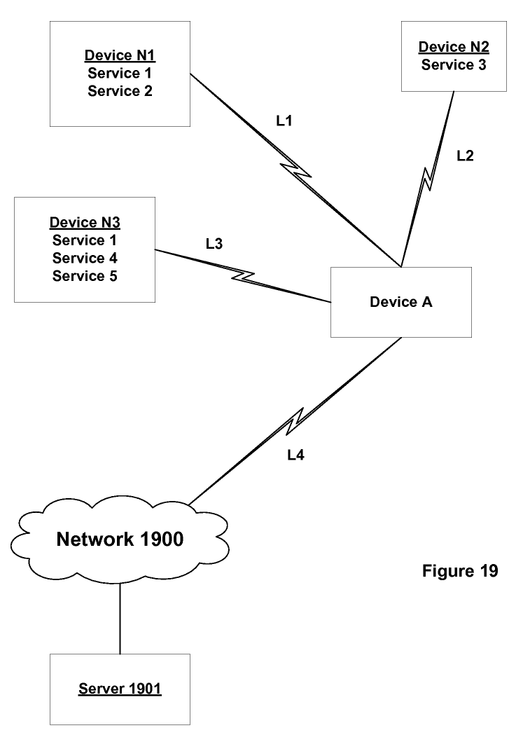

It will be appreciated that the example of FIGS. 14-18, involving the class Person, is provided primarily by way of illustration. FIG. 19 illustrates in schematic format a more likely environment for the approach described herein. In particular, FIG. 19 depicts a pervasive or ubiquitous computing environment. Such an environment typically includes at least one mobile or portable/movable device which interacts with other devices, fixed or also mobile, in order to access services available in that locality. As a mobile device moves from one locality to another, it encounters different devices, and hence a changing set of available services. In today's terminology one implementation of such a device might be referred to as a mobile telephone; however, the capability of such devices is rapidly increasing and such devices may in future reflect a wide variety of functions and nomenclature.

FIG. 19 depicts a device, device A, for use in the pervasive computing environment. Device A might, for example, represent a mobile telephone, a portable or handheld computing device, a portable music or video player, a GPS navigation unit, some device that provides some combination of such functionality, or any other suitable device. Furthermore, device A might be intrinsically portable (such as for a mobile telephone) or somehow incorporated into a moving or movable system, such as a motor car. Device A might also represent a device such as a digital television that normally remains in one place, but which may need to discover and then interact with a potentially variable set of devices in its immediate locality, such as set-top box, hard disk recorder, etc.

It is assumed that device A, on entering the ubiquitous environment, tries to determine the available devices and services within the environment. Therefore Device A uses wireless link L1 to contact device N1, which offers services 1 and 2, wireless link L2 to contact device N2, which offers service 3, and wireless link L3 to contact device N3, which offers services 1, 4 and 5. Device A can therefore retrieve the XML sources relating to devices N1, N2 and N3, and their associated services from the respective devices. (This corresponds to step 112 in FIG. 2, with the device and service descriptions corresponding to the descriptions 805 and 820 respectively in FIG. 8). Note that Devices N1-N3 may be fixed, or may themselves be mobile computing devices, perhaps temporarily in the same environment as Device A.

Device A can also access server 1901 via wireless link L4 and network 1900 (also potentially via one or more devices, not shown in FIG. 19). This allows any linked XML source on server 1901 to be retrieved by Device A. (This corresponds to step 260 in FIG. 5, with the retrieved XML source corresponding to the modality descriptions 815 in FIG. 8).

Note that Device A may itself store XSLT Script 840 and/or OWL Domain Ontology 835 (as used in FIG. 8 to convert the DOM files into ontologies). Alternatively, the Device A may retrieve the XSLT Script 840 and/or the OWL Domain Ontology as and when required over network 1900 or over any other appropriate (and accessible) network connection.

When the retrieved XML files for all the different devices have been retrieved and transformed, Device A automatically has at its disposal a comprehensive, semantic (ontological) description of its environment, and the various available devices and services.

One example of the use of the approach described herein is to facilitate versioning. Thus a chain of OWL instances files, each pertaining to a different version, can be cascaded together. Any new information from an instance file can then be automatically incorporated into an existing merged result.

In conclusion, various embodiments of the invention have been described by way of example only, and having regard to particular environments and application requirements. The person of ordinary skill in the art will appreciate that many variations may be made to the particular implementations described herein without departing from the spirit and scope of the invention as defined by the appended claims.

1. A method for use by a device in a pervasive computing environment, said method comprising:
receiving at the device multiple XML sources describing devices and/or services currently available to said device within the pervasive computing environment; and
transforming by the device the multiple XML sources into a single ontology instance representing the devices and/or services currently available to said device within the pervasive computing environment.

2. The method of claim 1, wherein at least some of the multiple XML sources are received via a wireless communications link.

3. The method of claim 1, wherein the step of transforming comprises:
converting the XML sources into at least two separate ontology instances; and
merging together the at least two separate ontology instances into said single ontology instance.

4. The method of claim 3, wherein said merging comprises:
typecasting each of the at least two ontology instances into a corresponding set of RDF (Resource Description Framework) statements;
performing a union operation on the sets of RDF statements corresponding to the at least two ontology instances; and
typecasting the resulting single set of RDF statements back to an ontology to produce the single ontology instance.

5. The method of claim 4, wherein individuals in different XML sources are merged based on their RDF:ID.

6. The method of claim 3, wherein the two separate ontology instances share a domain ontology.

7. The method of claim 3, wherein the step of transforming further comprises:
converting the XML sources into at least two document object models; and
converting each document object model into an ontology instance.

8. The method of claim 7, wherein the multiple XML sources comprise two categories, the first category comprising locally available service descriptions, and the second category comprising modality extensions, wherein the XML sources in the first category include one or more links to the XML sources in the second category, and wherein the XML sources in the first category are converted into a first document object model, and the XML sources in the second category are converted into a second document object model.

9. The method of claim 3, wherein converting one or more XML sources into an ontology instance comprises:
forming a document object model from the one or more XML sources; and
using an XSLT file and a domain ontology to convert the document object model into an ontology instance.

10. The method of claim 1, wherein the step of transforming comprises:
combining the XML sources into a single document object model; and
converting the single document object model into said single ontology instance.

11. The method of claim 10, further comprising using an XSLT file and a domain ontology to convert the single document object model into the single ontology instance.

12. The method of claim 1, wherein the multiple XML sources comprise two categories, the first category comprising locally available service descriptions, and the second category comprising modality extensions, wherein the XML sources in the first category include one or more links to the XML sources in the second category.

13. The method of claim 12, further comprising:
retrieving one or more XML sources in the first category;
parsing the one or more XML sources in the second category to obtain information identifying and locating any XML sources in the second category; and
retrieving any XML sources in the second category using said obtained information.

14. A device for use in a pervasive computing environment, said device including:
a communications facility for receiving at the device multiple XML sources describing devices and/or services currently available to said device within the pervasive computing environment; and
a processor for transforming the multiple XML sources into a single ontology instance representing the devices and/or services currently available to said device within the pervasive computing environment.

15. A computer program stored in a medium for use by a device in a pervasive computing environment, said computer program causing the device to implement a method comprising:
receiving at the device multiple XML sources describing devices and/or services currently available to said device within the pervasive computing environment; and
transforming by the device the multiple XML sources into a single ontology instance representing the devices and/or services currently available to said device within the pervasive computing environment.

16. A computer-implemented method for automatically combining multiple ontology instances sharing the same domain ontology, said method comprising:
typecasting each of the multiple ontology instances into a corresponding set of RDF (Resource Description Framework) statements;
performing a union operation on the sets of RDF statements corresponding to the multiple ontology instances; and
typecasting the resulting single set of RDF statements back to an ontology to produce the combined ontology instance.

17. The method of claim 16, wherein performing a union operation on the sets of RDF statements includes merging root nodes into one and dropping duplicate nodes.

18. The method of claim 17, wherein root nodes are merged based on a shared universally unique identifier.

19. The method of claim 16, wherein combining multiple ontology instances sharing the same domain ontology is performed within a Jena framework.

20. The method of claim 16, wherein the multiple ontology instances for combination consist of a first ontology instance and a second ontology instance.

21. The method of claim 16, wherein the multiple ontology instances relate to device capabilities and services for a pervasive computing device.
